(19) United States
(12) Patent Application Publication
(10) Pub. No.: US 2024/0182185 A1
(43) Pub. Date: Jun. 6, 2024

(54) PHASED CONTROL OF MULTIPLE SPACECRAFT DURING A LOW-THRUST ORBIT TRANSFER MANEUVER

(71) Applicant: The Boeing Company, Chicago, IL (US)

(72) Inventors: Andrew H. Giacobe, Long Beach, CA (US); Jeffrey S. Noel, Ashland, OR (US); David Freeman, Torrance, CA (US)

(73) Assignee: The Boeing Company, Chicago, IL (US)

(21) Appl. No.: 18/060,804

(22) Filed: Dec. 1, 2022

(51) Int. Cl. B64G 1/24; B64G 1/00

(52) U.S. Cl. CPC B64G 1/242; B64G 1/002

(57) ABSTRACT

A method for controlling phased transfer of multiple spacecraft from a separation orbit to a target orbit includes, while maintaining an in-phase relationship of the spacecraft relative to each other within the separation orbit, computing, via a control system, respective desired trajectories for a lead spacecraft and two or more follower spacecraft to reach the target orbit. The method includes establishing a constant phase offset between the spacecraft in mean anomaly of the separation orbit. During a series of transfer orbits of the spacecraft from the separation orbit to the target orbit, the method includes applying the desired trajectories via the control system such that the constant phase offset is maintained and the follower spacecraft are simultaneously transferred to the target orbit in-phase with the lead spacecraft. The control system includes a processor and computer-readable storage medium programmed with instructions for performing the method.

### BACKGROUND

Spacecraft control systems and related operational control methodologies are used to achieve desired transfer orbit trajectories of various types of spacecraft, including but not limited to satellites, rockets, space vehicles, and space planes. While such spacecraft may employ a chemical, solid, and/or gaseous propulsion system, the spacecraft are typically equipped with a low-thrust propulsion system suitable for sustained propulsion over longer-range or extended-duration missions. For instance, the low-thrust spacecraft may include an electrical propulsion system (EPS), e.g., a Xenon-ion propulsion system (XIPS) or another application-suitable ion or plasma engine.

Ion propulsion in particular involves high-voltage ionization of an inert propellant gas, e.g., Xenon, for the purpose of energizing sustained low-thrust propulsion. Generated ions are accelerated by electrostatic forces and thereafter exhausted from the spacecraft. As a result, the spacecraft moves in the opposite direction of the discharged exhaust stream. Relative to conventional rocket engines and thrustors, an EPS is capable of generating thrust with high exhaust velocities using a reduced amount of propellant. In turn, reducing the required propellant mass significantly decreases overall launch mass and costs associated with transferring the spacecraft from an injection or separation orbit into a final target orbit.

Low-thrust orbit transfer maneuvers performed using an EPS or similar thrusters can be used to gradually maneuver a spacecraft from an initial separation orbit, for instance an elliptical orbit near Earth, to a target orbit, e.g., a highly elliptical orbit (HEO), a medium Earth orbit (MEO), a geosynchronous Earth orbit (GEO), an interplanetary orbit, a lunar orbit, etc. The orbit transfer process occurs via constantly steered thrust, which in an aspect of the disclosure utilizes a steering law referred to in the art as “compound steering”. As appreciated in the art, the compound steering law combines various spacecraft steering strategies to simultaneously accomplish orbital objectives, including an orbital eccentricity target and a semi-major axis (SMA) target, while allowing for continuous firing of the spacecraft's thrusters.

### SUMMARY

The present disclosure may be used during spacecraft flight control operations to establish and maintain a desired relative position or phasing between multiple spacecraft within an initial orbit. As contemplated herein, the initial orbit is an insertion/entry orbit, e.g., an elliptical Earth orbit, into which two or more satellites or other spacecraft are delivered, typically via a single launch vehicle. These “co-launched” spacecraft may have an Electric Orbit Raising (EOR) duration on the order of several months or longer. For such missions, low-thrust transfers are optimized to move the spacecraft to the target orbit using constantly steered thrust. Embodiments of the compound steering law forming a basis for the modifications and implementations of the present disclosure are disclosed in U.S. Pat. No. 8,457,810 B1 to Batla et al., issued on Jun. 4, 2013, and U.S. Pat. No. 8,930,048B1 to Batla et al., issued on Jan. 6, 2015, both of which are incorporated by reference in their entireties.

An aspect of the disclosure includes a method for controlling phasing of multiple spacecraft during a transfer maneuver from an insertion or separation orbit to a target orbit. The spacecraft include a designated primary or “lead” spacecraft and multiple “follower” spacecraft as described herein. An exemplary embodiment of the method commences while a control system maintains a closely spaced in-phase relationship of the spacecraft within the separation orbit. During this phase of spaceflight operations, the method includes computing respective desired trajectories for the lead and follower spacecraft needed to reach the target orbit, and establishing a constant phase offset between the spacecraft as a difference in mean anomaly in the separation orbit.

During a series of transfer orbits of the spacecraft from the separation orbit to the target orbit, e.g., over the course of the above-noted EOR duration, the method may include applying the desired trajectories via the control system such that the constant phase offset is maintained and the follower spacecraft are simultaneously transferred to the target orbit in-phase with the lead spacecraft.

Applying the respective desired trajectories may include modifying an in-plane change in velocity (Δv) component of the various spacecraft, individually, in relation to an out-of-plane Δv component for each respective one of the spacecraft.

One or more implementations of the present method include implementing a variation of the above-summarized compound steering control law via the control system. As appreciated in the art, the compound steering control law utilizes a plurality of weight factors. Within the scope of the present disclosure, the act of modifying the in-plane Δv component in relation to the out-of-plane Δv component includes manipulating a predetermined one of the weight factors, specifically the “β weight factor” as described in detail below. This control action, which occurs iteratively over a duration of the series of transfer orbits, allows the control system to control mean motion of the multiple spacecraft.

The method in accordance with the present disclosure may include calculating the mean motion as a function of respective semi-major axes (SMAs) of the multiple spacecraft, and also calculating a delta phase rate needed to establish and maintain the constant phase offset between a sequential spacecraft pair of the multiple spacecraft in one or more of the series of transfer orbits. As used herein, the term “sequential pair” refers to a sequentially consecutive pair of the multiple spacecraft within a given orbit. This value may be calculated as a difference between the respective mean motion of the sequential spacecraft pair.

Applying the phase rate in one or more embodiments may include changing a relative SMA between the spacecraft pair at a defined rate according to a predetermined relationship. The predetermined relationship may in turn include changing an SMA of a designated spacecraft of the pair in relation to an SMA of an additional spacecraft of the pair, with this change occurring in a first direction. This action continues until no more than half of a desired time to achieve the constant phase offset has elapsed. The method thereafter includes changing the SMA of the designated spacecraft in a second direction, which is opposite the first direction, until the desired time to achieve the constant phase offset has elapsed.

Alternatively, the predetermined relationship can include changing the SMA of the designated spacecraft in relation to the SMA of the additional spacecraft in the first predetermined direction, and thereafter holding the SMA of the designated spacecraft at a fixed semi-major axis offset for a calibrated duration. The method in this embodiment thereafter includes changing the SMA of the designated spacecraft in the second direction, which is opposite the first direction as noted above, until the desired time to achieve the constant phase offset has elapsed.

Maintaining the constant phase offset may include periodically repeating the various steps of the above-summarized method during the series of transfer orbits to properly account for any thrust variations and/or mass variations that may exist between the multiple spacecraft.

An aspect of the disclosure includes deploying the multiple spacecraft from a single launch vehicle, e.g., a high-thrust multi-stage rocket. Deploying the multiple spacecraft from the single launch vehicle may include deploying multiple satellites from the single launch vehicle in one or more embodiments.

Also disclosed herein is a control system operable for controlling multiple spacecraft during a transfer from a separation orbit to a target orbit. The multiple spacecraft include a designated lead spacecraft and multiple follower spacecraft. The control system in this configuration includes one or more processors and a tangible, non-transitory computer readable storage medium/media on which is recorded an instruction set.

Execution of this instruction set by the processor(s) causes the control system, while maintaining an in-phase relationship of the multiple spacecraft relative to each other within the separation orbit, to compute respective desired trajectories for the lead spacecraft and the follower spacecraft needed to reach the target orbit. While maintaining the in-phase relationship, the control system establishes a constant phase offset between the multiple spacecraft as a difference in mean anomaly in the separation orbit. During a series of transfer orbits of the multiple spacecraft from the separation orbit to the target orbit, the control system applies the respective desired trajectories such that the constant phase offset is maintained and the follower spacecraft are simultaneously transferred to the target orbit in-phase with the lead spacecraft.

The above-summarized method in accordance with an alternative embodiment includes deploying the multiple spacecraft into a separation orbit from a single launch vehicle. While maintaining an in-phase relationship of the multiple spacecraft relative to each other within the separation orbit, the method includes implementing a compound steering control law via a control system, with the compound steering law having a plurality of weight factors. The control system also computes respective desired trajectories for the lead spacecraft and the follower spacecraft to reach the target orbit. As part of this embodiment of the disclosed method, the method includes establishing a constant phase offset between the multiple spacecraft as a difference in mean anomaly in the separation orbit.

During a series of transfer orbits of the multiple spacecraft from the separation orbit to the target orbit, the method includes applying the respective desired trajectories via the control system such that the constant phase offset is maintained and the follower spacecraft are simultaneously transferred to the target orbit in-phase with the lead spacecraft. This action may include modifying an in-plane change in velocity (Δv) component of each of the multiple spacecraft in relation to an out-of-plane Δv component for each of the multiple spacecraft by manipulating a predetermined one of the weight factors. This occurs over a duration of the series of transfer orbits to thereby control a mean motion of each of the multiple spacecraft.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 illustrates multiple spacecraft upon entering a separation orbit in accordance with a possible implementation of the present control strategy.

FIG. 2A illustrates a prior art steering law for an acceleration component of a spacecraft that is perpendicular to the line of apsides of the spacecraft's orbit.

FIG. 2B illustrates a prior art steering law for an acceleration component that is perpendicular to the radius vector of the spacecraft's orbit.

FIG. 2C illustrates a prior art steering law for an acceleration component that is along the velocity/anti-velocity vector of the spacecraft's orbit.

FIG. 3 is a diagram of an application of the present method when transitioning multiple co-launched spacecraft from a separation orbit to a target orbit in accordance with the disclosure.

FIGS. 4 and 5 illustrates a simplified embodiment in which three spacecraft are moving in phase (FIG. 4) and with a controlled phase offset (FIG. 5) within a separation orbit.

FIGS. 6 and 7 are time plots describing representative adjustments in a semi-major axis of a representative spacecraft of FIG. 1 within the scope of the disclosure.

FIG. 8 is a plot of relative phase in degrees versus orbit raising time in months in accordance with an aspect of the disclosure.

FIG. 9 illustrates a portion of FIG. 8 to illustrate interleaving sinusoids.

FIG. 10 is a comparative plot of relative phase in degrees versus orbit raising time in months in accordance for co-launched spacecraft absent the present teachings.

FIG. 11 is a flow chart describing an embodiment of the method disclosed herein.

The present disclosure is susceptible to modifications and alternative forms, with representative embodiments shown by way of example in the drawings and described in detail below. Inventive aspects of this disclosure are not limited to the disclosed embodiments. Rather, the present disclosure is intended to cover alternatives falling within the scope of the disclosure as defined by the appended claims.

### DETAILED DESCRIPTION

Embodiments of the present disclosure are described herein. It is to be understood, however, that the disclosed embodiments are illustrative examples, and that other embodiments can take various and alternative forms. The Figures are not necessarily to scale, and may be schematic. Some features may be exaggerated or minimized to show details of particular components. Therefore, specific structural and functional details disclosed herein are not to be interpreted as limiting, but merely as a representative basis for teaching one skilled in the art to variously employ the present disclosure.

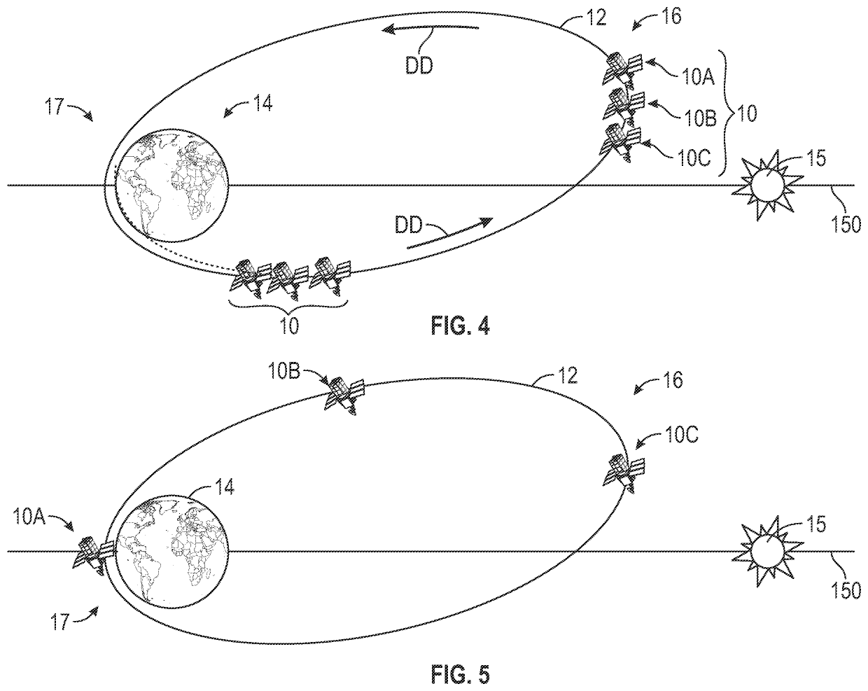

Referring to the drawings, wherein like reference numbers refer to the same or like components in the several Figures, multiple spacecraft 10 are shown clustered closely together or in-phase with one another subsequent to a launch. In the illustrated example scenario, the multiple spacecraft 10 include three spacecraft 10, i.e., a first spacecraft 10A, a second spacecraft 10B, and a third spacecraft 10C. The spacecraft 10 may be launched together via a single launch vehicle (not shown), typically a multi-stage rocket. Such a launch vehicle may deliver the multiple spacecraft 10 to an insertion point in an insertion or separation orbit 12 (see FIGS. 4 and 5), e.g., an elliptical orbit around the Earth 14 or another celestial body depending on the application. When this occurs, the multiple spacecraft 10 are deemed to be “co-launched” within the scope of the disclosure.

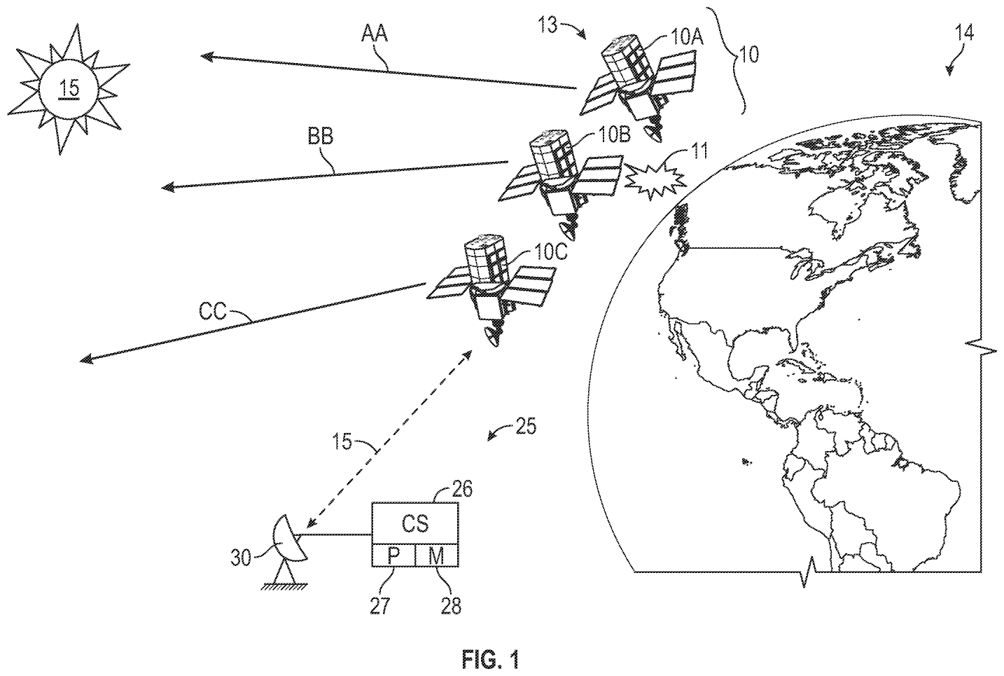

The multiple spacecraft 10 of FIG. 1 may be variously embodied as satellites 13 as shown, or as rockets, space vehicles, space planes, etc. When embodied as satellites 13, the multiple spacecraft 10 may be configured for use as part of a constellation of government or commercial platforms equipped for delivering, e.g., digital communications, mobile communications, broadband internet connectivity, streaming entertainment, etc. Regardless of their assigned missions, the multiple spacecraft 10 are constructed herein as low-thrust space vehicles propelled by thrust generated from ion engines, plasma thrusters, or other suitable low-thrust devices upon reaching the separation orbit 12.

Communications with the multiple spacecraft 10 and a subsequent control strategy as described herein can be established and maintained using a network of ground stations 25, with one such ground station 25 depicted schematically in FIG. 1 for illustrative simplicity. Each ground station 25 may include a control system (CS) 26 having one or more processors (P) 27 and tangible, non-transitory memory (M) 28 in the form of computer-readable storage medium or media. The memory 28 may be programmed with instructions embodying a method 100, an embodiment thereof being shown in FIG. 11 and described below. The control system 26 may include or be connected to a transceiver 30, which in turn allows the ground station 25 to communicate with the spacecraft 10 when in range. Such two-way communication is represented by double-headed arrow 15 in FIG. 1.

The representative ground station 25, by executing the present control strategy, is able to coordinate phasing and thus establish and maintain relative positioning of the multiple spacecraft 10 within an orbit plane. The disclosed solutions are useful for maintaining a desired phase offset between the spacecraft 10 during their collective transfer to a desired target orbit. That is, after initial insertion into the separation orbit 12 at a separation point 11 in the non-limiting scenario of FIG. 1, the spacecraft 10 are transferred over an Electric Orbit Raising (EOR) duration to another orbit between the Earth 14 and the sun 15 as indicated by arrows AA, BB, and CC for the spacecraft 10A, 10B, and 10C, respectively.

As part of the compound steering law applied and selectively modified herein, a specific weight factor referred to as the “3 weight factor” and denoted as op is manipulated by the control system(s) 26 of the various ground stations 25 to control the respective phases of each spacecraft 10A, 10B, and 10C in relation to a designated primary or “lead” spacecraft 10A, 10B, or 10C. Within the scope of the disclosure, the lead spacecraft can be defined arbitrarily for a given mission, but is typically a particular one of the multiple spacecraft 10 that will reach the orbit 12 the fastest, e.g., due to a slightly lower mass and/or a higher thrust relative to the other spacecraft 10. As a result of implementing the present control solutions, the spacecraft 10 are ultimately transferred to the desired target orbit with a planned angular offset in their respective transfer orbits, and with a minimized probability of a collision between the spacecraft 10 during the transfer maneuver(s). The term “maneuver” as used herein, unless otherwise stated, refers to the controlled transfer of the multiple spacecraft 10 to the target orbit 120 over the full EOR duration. However, “maneuver” can also describe a starting and stopping sequence of a thruster, which happens once per orbital revolution in most cases.

To this end, the control system 26 of FIG. 1 may include one or more processors 27 in the form of central processing units (CPUs), processor cores, electronic controllers, microcontrollers, Application Specific Integrated Circuit(s) (ASICs), Field-Programmable Gate Array (FPGAs), electronic circuit(s), and the like, with associated transitory and non-transitory memory/storage component(s) inclusive of the memory 28. The memory 28 may also include other non-transitory memory or tangible storage devices, e.g., read only memory, programmable read only memory, solid-state memory, random access memory, optical and/or magnetic memory, etc.

The memory 28, on which computer-readable instructions embodying the method 100 may be recorded, is capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

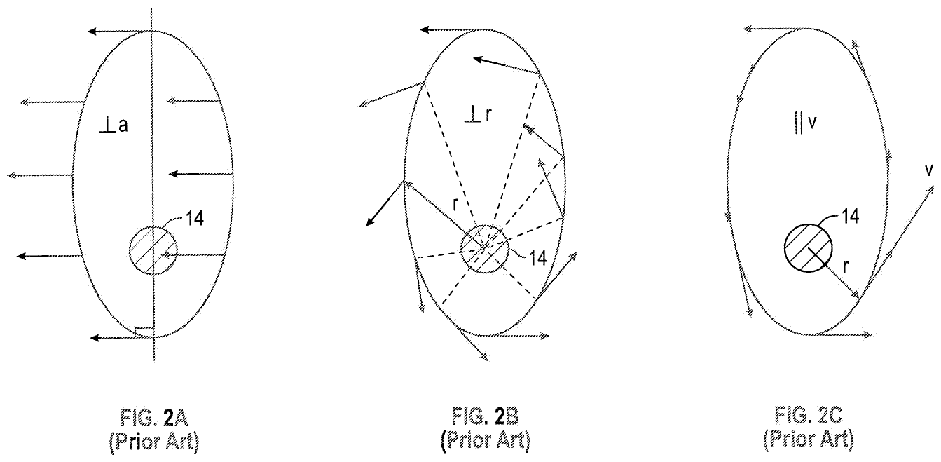

Referring briefly to prior art FIGS. 2A-2C, these three Figures illustrate three commonly used steering laws for controlling low-thrust orbiting missions. The illustrated methodologies are used to determine the direction of an in-plane component of acceleration to be applied to a given spacecraft 10 during a transfer orbit mission of the type contemplated herein. FIG. 2A shows the steering law from an acceleration component that is perpendicular to the line of apsides (⊥ a). FIG. 2B shows the steering law for an acceleration component that is perpendicular to the radius vector (⊥ r). FIG. 2C illustrates the steering law for an acceleration component that is along the velocity/anti-velocity vector (∥v). The applicability of the representative steering laws of FIGS. 2A-C for a transfer orbit mission is a function of the initial orbit for each of the spacecraft 10.

The representative steering laws of FIGS. 2A-2C are used to achieve a specific orbit. For instance, the steering law illustrated in FIG. 2A is typically used to target the orbital eccentricity, while the steering laws of FIGS. 2B and 2C are used to target the orbital semi-major axes (SMAs). With a few exceptions, the steering laws of FIGS. 2A-2C and their respective objectives are exclusive of each other, and there is a conflict between them when it is desirable to achieve targets for the SMAs and the orbit eccentricity parameters. For this reason, a typical solution is to divide the mission into distinct phases, with each phase employing a different steering law in order to achieve a given orbital target. In the present approach, the individual steering laws of FIGS. 2A-C are replaced with a modified version of the compound steering law noted above, with specific manipulation of the β weight factor, i.e., ω_{β}.

In the compound steering law disclosed in the above-incorporated references of U.S. Pat. Nos. 8,457,810 B1 and 8,930,048B1, both to Batla et al., β is generally defined as an angular inclination of the orbital plane of a given one of the spacecraft 10 and the sun 15. For the purposes of compound steering, β can be expressed as the inverse tangent of the ratio of thruster ontime (Δt) for inclination to Δt in-plane, i.e.,:

$$β = {tan}^{- 1} [ \frac{Δ {t}_{inclination}}{Δ {t}_{i n - plane}} ] ,$$

$$where Δ {t}_{in - plane} is computed from \vert {\vec{V}}_{eccentricity} + {\vec{V}}_{circle} \vert .$$

$${β}_{0} = {ω}_{β} \frac{Δ {t}_{inclination}}{Δ {t}_{i n - plane}}$$

where β₀ is used to control the magnitude of the angle β. ω_{β} is the parameter manipulated herein as part of the disclosed method. Manipulation of this particular β weight factor is used herein to change the β angle, i.e., the out-of-plane angular component, and the ratio between the applied in-plane Δt and the applied out-of-plane Δt.

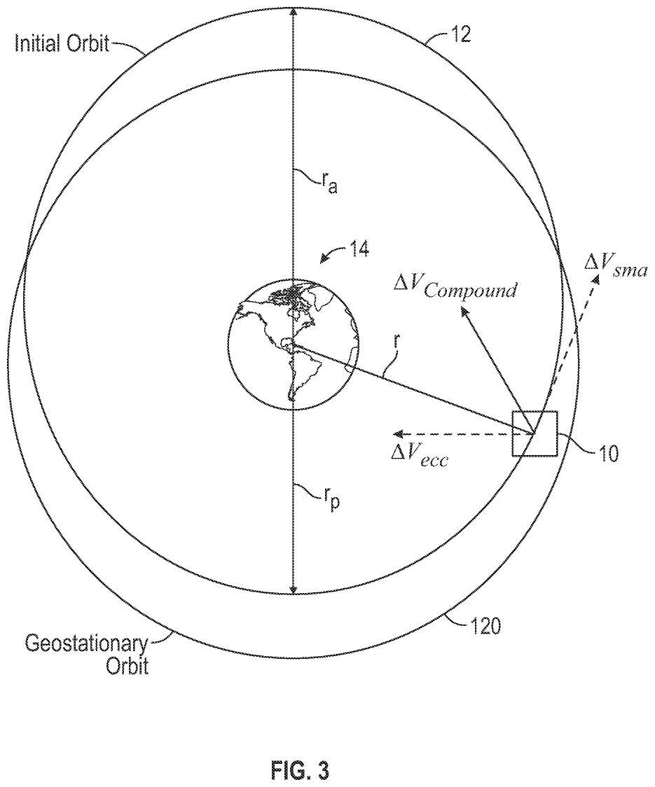

FIG. 3 illustrates a transition from an initial orbit, e.g., the representative separation orbit 12 of FIG. 1, to a target orbit 120. As shown, the target orbit 120 is represented for the purpose of illustration as a geosynchronous orbit of the Earth 14. Other orbits may be used as the target orbit 120 in other implementations and use cases. Also shown in FIG. 3 is a compound steering direction (ΔV_{compound}) required for reaching the target orbit 120. The separation orbit 12 has an apogee radius (rₐ) and a perigee radius (rₚ), along with a radius (r) to the Earth 14. The compound steering direction (ΔV_{compound}) is the direction of the vector sum of the change in velocity needed to achieve the target SMA (ΔVₛₘₐ) and the change in velocity required to achieve the target orbit eccentricity (ΔV_{ecc}). Thrusters of the multiple spacecraft 10 are fired in the compound steering direction (ΔV_{compound}) to transition from the separation orbit 12 to the target orbit 120. The manner in which such firing and adjustments are made is regulated by the control systems 26 of FIG. 1 at the various ground stations 25 using the method 100 of FIG. 11 or embodiments thereof, with ultimate in-mission manipulation of the above-noted p weight factor (op).

Referring now to FIG. 4, in a typical launch event in which the multiple spacecraft 10 are co-launched via a single launch vehicle, e.g., as part of a constellation of communications satellites, an initial launch trajectory from the Earth 14 is used to deliver the spacecraft 10 to the separation orbit 12. The Earth 14 and the sun 15 are aligned on a plane 150 as shown, with the spacecraft 10 orbiting the Earth 14 in the path of the separation orbit 12. In the representative case of FIG. 4, the separation orbit 12 is elliptical, and therefore the spacecraft 10 travelling in the direction of arrows DD will move faster at perigee 17 than at apogee 16, as will be appreciated by those skilled in the art.

As the multiple spacecraft 10 are substantially in-phase with one another after insertion into the separation orbit 12, the spacecraft 10 will remain closely located as they move in the path of the separation orbit 12. In the representative orbiting event of FIG. 4, three of the spacecraft 10 are co-launched and orbiting the Earth 14. In other missions, as few as two of the spacecraft 10 or more than the illustrated three spacecraft 10 may be co-launched. The spatial arrangement of FIG. 4 will remain essentially unchanged until the transfer orbit commences by firing of one or more thrusters located aboard the spacecraft 10. The present teachings are intended to avoid collisions between the spacecraft 10A, 10B, and 10C during the ensuing orbit transfer maneuver(s) to a desired target orbit.

Desired Phase Offset Strategy: referring now to FIG. 5, a goal of the present disclosure to be accomplished via programming of the above-noted control system 26 of FIG. 1 is to maintain a constant phase offset between the various spacecraft 10, e.g., the representative spacecraft 10A, 10B, and 10C. FIG. 5 depicts a non-limiting implementation using mean anomaly offsets of 90° and 180°. However, other fixed offsets may be used in different embodiments without departing from the scope of the present disclosure. The constant offsets contemplated herein are established in mean anomaly, as the elliptic nature of the transfer orbits results in variation of the angular rate. The solutions described herein therefore apply a modified version of the compound steering law to achieve desired phasing of the spacecraft 10A, 10B, and 10C. As used herein, the term “mean anomaly” refers to the fraction of an elliptical orbit's period that has elapsed since the orbiting body passed periapsis, with the mean anomaly typically being expressed as an angle.

The multiple spacecraft 10 have a phase rate while in orbit. The relative phase rate is zero when the phase offset is not changing. To establish a phase offset as used herein, a change must occur in the phase rate. This change is referred to herein as the “delta phase rate”. In order to achieve a desired delta phase rate, the SMAs of a pair of the spacecraft 10 must be moved apart. The spacecraft 10 having the higher SMA will move at a slower angular rate than the spacecraft 10 having the lower SMA, because the higher SMA will have a longer period to rotate through 360°. To slow the delta phase rate, the SMAs should be brought closer together. To stop the delta phase rate, the SMAs should be held equal. These steps are performed using the modified compound steering law set forth herein, specifically by manipulating the β weight factor during the progression or series of orbits of the spacecraft 10 as they are moved to the target orbit. Manipulation of the β weight factor in turn changes the in-plane component of Δv in relation to the out-of-plane component of Δv. For a given one of the spacecraft 10, therefore, increasing the in-plane Δv provides a faster rising SMA, while increasing the out-of-plane Δv provides a slower rising SMA.

To provide an offset in phase, the SMA of one spacecraft 10 is intentionally moved away from the SMA of another of the spacecraft 10. SMA offset provides a change in mean motion (n) which can be converted to a change in degrees per second:

$$n = ( \frac{180 °}{π} ) \sqrt{\frac{μ}{{a}^{3}}}$$

where μ is an Earth gravitational parameter and a is the SMA of the subject spacecraft 10. The delta phase rate \dot{θ} in rad/sec is the difference between the mean motion of two orbits, i.e.,:

\dot{θ}=n₂−n₁.

The implementation described herein may include applying the delta phase rate to the multiple spacecraft 10 by changing a relative SMA between the sequential spacecraft pair, e.g., the spacecraft 10A and 10B, at a defined rate according to a predetermined relationship. The predetermined relationship can include changing an SMA of a designated one of the spacecraft 10 of the sequential spacecraft pair in relation to an SMA of an additional one of the spacecraft 10 of the sequential spacecraft pair in a first direction until no more than half of a desired time to achieve the constant phase offset has elapsed, and thereafter changing the SMA of the designated spacecraft in a second direction opposite the first direction until the desired time to achieve the constant phase offset has elapsed.

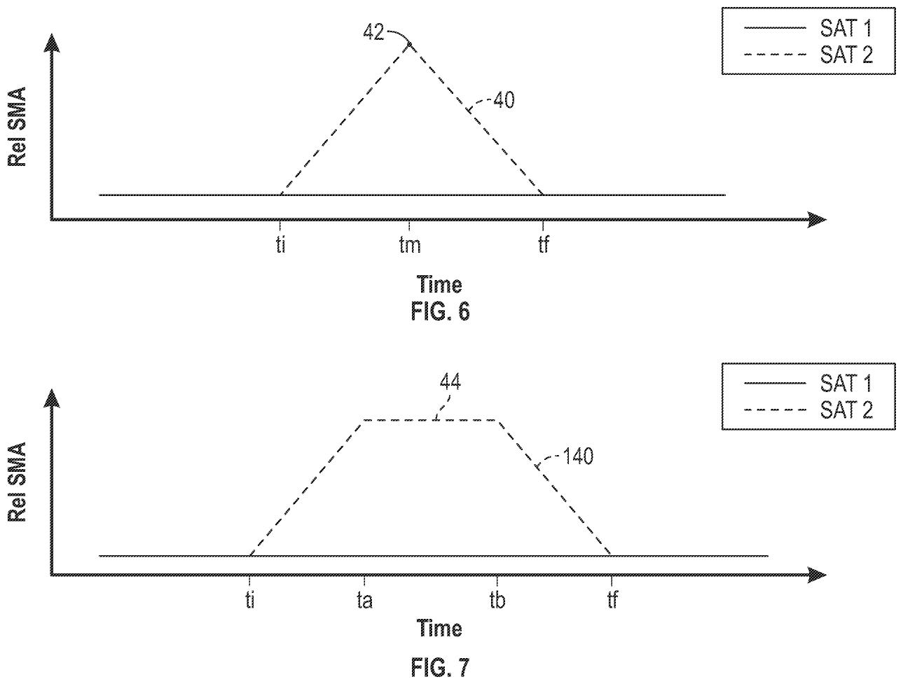

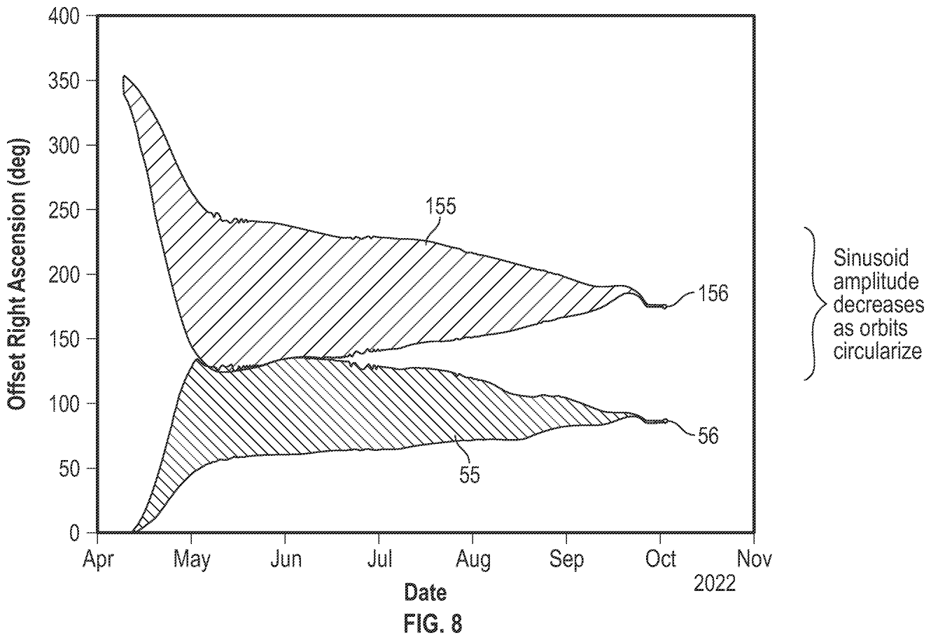

Referring briefly to FIGS. 6 and 7, which depict two representative approaches in which relative SMA (“Rel SMA”) is shown on the vertical axis and time is shown on the horizontal axis, the predetermined relationship noted above may be triangular (FIG. 6) or trapezoidal (FIG. 7) in non-limiting embodiments. In the approach of FIG. 6 represented as trace 40, for example, the SMA of one spacecraft (SAT 2), e.g., the spacecraft 10A, is increased (or decreased) in relation to another spacecraft (SAT 1), e.g., the spacecraft 10B or 10C, starting at time tᵢ, and ramped at a calibrated rate until half the time to achieve the phase has elapsed, i.e., until time tₘ. Trace 40 then returns to the SMA of spacecraft 10A in this example, reaching this level at time t_{f}. The total duration (X) of the illustrated trace 40 from tᵢ to t_{f} could be about X=30 days in a possible implementation in which the transfer from separation orbit 12 to target orbit 120 of FIG. 3 is about 6 months. Due to the low-thrust configuration of the various spacecraft 10, the changes in thrust direction and resultant motion are not instantaneous.

As shown in FIG. 7, the triangular approach of FIG. 6 may be modified to produce a trapezoidal trace 140, with trace 140 having a fixed offset 44. Here, after first changing the SMA of the designated spacecraft (SAT 2) in relation to the SMA of the additional spacecraft (SAT 1) in the first predetermined direction, which is the positive direction in the non-limiting embodiments of FIGS. 6 and 7, from time tᵢ until an intermediate time tₐ, the control system(s) 26 of FIG. 1 may hold the SMA of the designated spacecraft (SAT 2) at a fixed SMA offset for a calibrated duration, i.e., tₐ until the later intermediate time t_{b}, and thereafter changing the SMA of the designated spacecraft (SAT 2) in the second direction opposite the first direction, i.e., from to until t_{f}, until the desired time to achieve the constant phase offset has elapsed. Other variations of the approaches of FIGS. 6 and 7 may be contemplated within the scope of the disclosure, e.g., linear increasing or decreasing of the β angle resulting in a parabolic-shaped rise and fall of the relative SMA, etc.

While it may be theoretically possible to converge on an offset and maintain that offset without further control of the β weight factor as disclosed herein, real world issues can prevent that from happening. For instance, actual thrust levels of the various spacecraft 10 of FIGS. 4 and 5 will tend to vary from nominal values. The masses of the spacecraft 10 can differ. Lunar and solar gravity will act on the spacecraft 10 at different inertial positions, with contributions of the geopotential of the Earth 14 applying in a non-uniform manner to each spacecraft 10. Unmodeled perturbations could likewise have an effect over time.

To account for these and other factors, the methodology should be applied and reapplied on short intervals, e.g., 30-day steps over an exemplary X=6-month long transfer, so as to control the offsets whenever deviations occurs. To this end, the control system(s) 26 may be programmed with an optimizing routine, e.g., a cost function that avoids lapping of one spacecraft 10 by another. The introduction of constraints to a given phase result may produce a slight suboptimality to a minimum EOR duration sought by the unmodified compound steering law. However, the impact on EOR duration can be minimized while still enjoying the benefits of the present phasing strategy by monitoring the change in EOR duration relative to a reference value or target goal, or monitoring other factors such as propellant usage, Av, etc.

Referring now to FIG. 8, a representative duration of time is shown for two sequential spacecraft 10, e.g., the spacecraft 10A and 10C of FIGS. 4 and 5, on the horizontal axis (Date) in months. An offset right ascension from a third spacecraft, e.g., 10B, is represented in degrees (deg) on the vertical axis. As shown, the transfer maneuver commences at the separation orbit 12, which may be elliptical as shown in FIGS. 4 and 5. That is, upon insertion into the separation orbit 12 the spacecraft 10 are located close together, i.e., with a phase offset of close to 0°. Within a representative period of thirty days, the spacecraft 10A and 10C are moved apart from the spacecraft 10B to an average 180° offset and 90° offset in traces 155 and 55, respectively.

Conversion between mean anomaly and instantaneous right ascension results in faster angular rate at perigee and slower angular rate at apogee, with apogee 16 and perigee 17 shown in FIGS. 4 and 5, with a midpoint not quite at the minor axis of the ellipsoid. Because all of the spacecraft 10 in the separation orbit 12 in FIG. 5 will experience the same acceleration and deceleration in angular rate, there is no risk of the phased spacecraft of FIG. 5 experiencing a close approach. By the end of the series of transfer orbits at points 56 and 156, the spacecraft 10 have reached a circular orbit, and thus an offset in mean anomaly is functionally the same as an offset in true anomaly or right ascension.

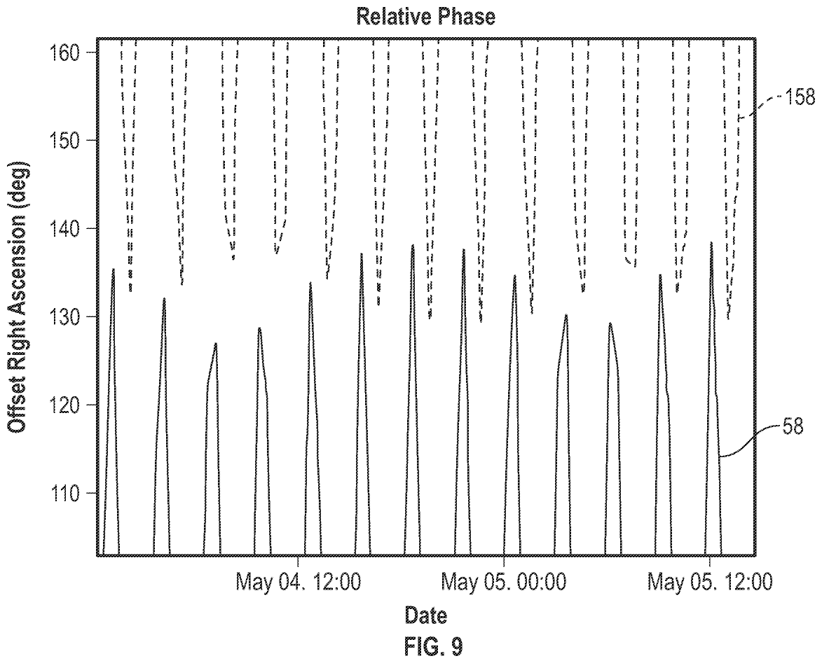

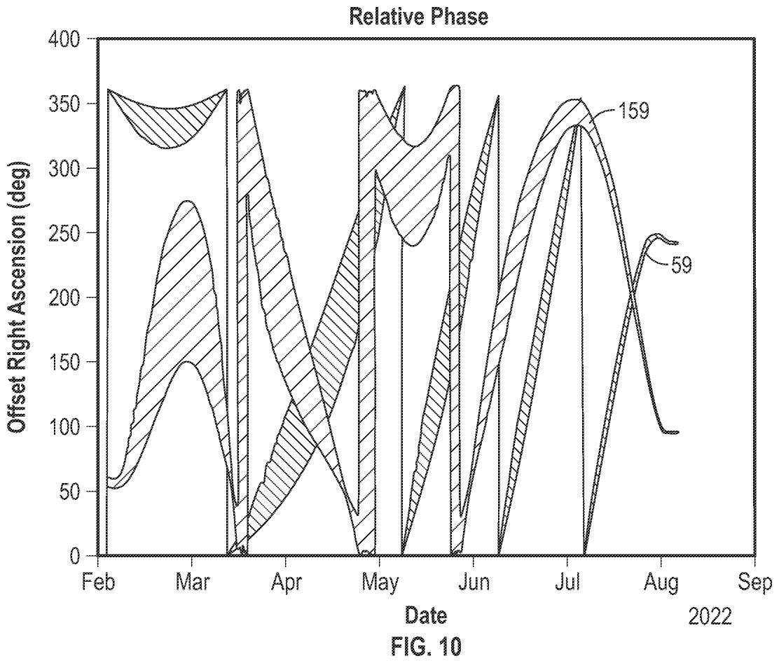

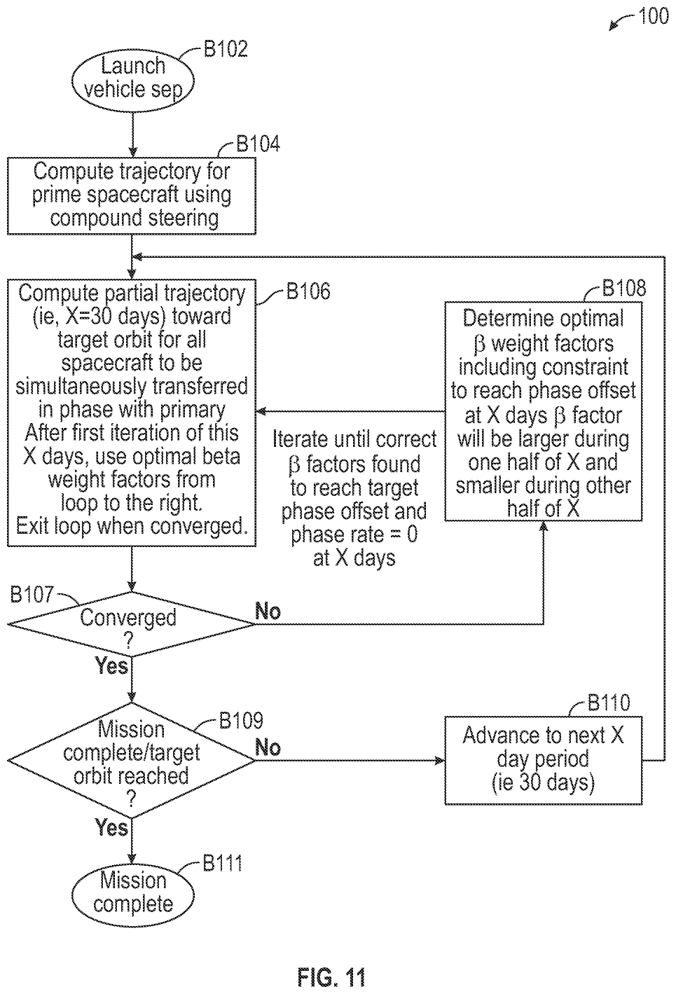

Elliptical orbits result in sinusoidal offset phase curves. That is, the traces of FIG. 8 do not intersect, since the shaded areas are comprised of a tightly compressed sinusoidal curve. This is best shown in the close-up view of FIG. 9 showing relative phase for a representative one-day period, with traces 58 and 158 corresponding to oscillations of traces 56 and 156 of FIG. 7. Rather, oscillation of the traces 55 and 155 of FIG. 8 drops as the spacecraft 10 transition to a circular orbit. Amplitudes of such oscillations will decrease as eccentricity of the orbit path decreases, with midpoints of the sinusoids at a desired phase offset. In contrast, FIG. 10 depicts the undesirable effects of unphased transfer, with traces 59 and 159 crossing over each other at various times during the series of transfer orbits. Implementation of the present solutions therefore can help reduce the probability of an inadvertent collision of the spacecraft 10 during the series of transfer orbits.

A method is provided for controlling a phased transfer of multiple spacecraft 10 from the separation orbit 12 to the target orbit 120 of FIG. 3, with the shape and eccentricity of the orbits 12 and 120 being exemplary and non-limiting. The multiple spacecraft 10 include a designated lead spacecraft 10. As disclosed above, the lead spacecraft can be defined arbitrarily for a given flight, e.g., as the spacecraft 10 that will reach its orbit 12 the fastest due to lower mass, higher thrust, or other factors.

In general, the method set forth herein proceeds while maintaining an in-phase relationship of the multiple spacecraft 10 relative to each other within the separation orbit 12. During this stage of operations, the method includes computing, via the control system(s) 26 of FIG. 1, respective desired trajectories for the lead spacecraft 10 and the follower spacecraft 10 to reach the target orbit 120. The method also includes establishing a constant phase offset between the multiple spacecraft 10 in mean anomaly of the separation orbit 12. During a series of transfer orbits of the multiple spacecraft 10 from the separation orbit 12 to the target orbit 120, the method in this exemplary embodiment includes applying the respective desired trajectories via the control system(s) 26 such that the constant phase offset is maintained and the follower spacecraft 10 are simultaneously transferred to the target orbit 120 in-phase with the designated lead spacecraft 10.

Applying the respective desired trajectories can include modifying an in-plane change in velocity (Δv) component of each of the multiple spacecraft 10 in relation to an out-of-plane Δv component for each of the multiple spacecraft 10. The method includes implementing a compound steering control law via the control system(s) 26, with the compound steering law having a plurality of weight factors, including the R weight factor considered herein.

Referring now to FIG. 11, the method 100 in accordance with one or more embodiments commences with block B102 with separation of multiple co-launched spacecraft 10 from a launch vehicle into the separation orbit 12 of FIG. 4. The method 100 then proceeds to block B102 with the spacecraft 10 moving in phase.

At block B104, each of the control systems 26 computes, using the compound steering law set forth above, required trajectories for the designated lead spacecraft 10 from among the co-launched spacecraft 10 needed to reach the target orbit 120. The method 100 then proceeds to block B106.

Block B106 entails computing partial trajectories, for an arbitrarily selected period of X days, e.g., X=thirty (30) days, for the spacecraft 10 to be simultaneously transferred in phase with the lead spacecraft 10 designated in block B104. As described below, performance of blocks B107 and B108 continue in an interactive loop until correct factors are found for reaching a target phase offset and a zero phase rate at X days. The method 100 then proceeds to block B107.

At block B107, each control system 26 determines if the target phase offset will be achieved and the phase rate will converge to zero at X days, e.g., using comparison logic, trajectory modeling, etc. The method 100 proceeds to block B108 if these values have not yet converged, with the method 100 otherwise proceeding to block B109.

At block B108, the control system 26 next determines an optimal value for the R weight factor. This includes determining one or more constraints to reach the desired phase offset at X days. As described above, the R weight factor will be larger during one half of the time period X and smaller during the other half of the time period X. Block B108 includes manipulating the R weight factor, e.g., by a calculated or fixed incremental amount. The method 100 then returns to block B106.

Block B109 is performed upon verification of convergence at block B107. In block B109, the control system 26 determines whether the spacecraft 10 have reached the target orbit 120. The method 100 proceeds to block B111 when the spacecraft 10 have reached the target orbit 120, with the method 100 otherwise proceeding to block B110.

Block B110 entails advancing to the next designated X-day period. In keeping with the X=30 days example, the next period would be days 31-60 of the mission. The method 100 then proceeds to block B106.

At block B111, the control system 26 may record in memory 28 of FIG. 1 that the mission is complete. The orbiting spacecraft 10, now properly spaced apart due to performance of the method 100, are thereafter are controlled in accordance with their assigned mission tasks.

To assist and clarify the description of various embodiments, various terms are defined herein. Unless otherwise indicated, the following definitions apply throughout this specification (including the claims). Additionally, all references referred to are incorporated herein in their entirety. “A”, “an”, “the”, “at least one”, and “one or more” are used interchangeably to indicate that at least one of the items is present. A plurality of such items may be present unless the context clearly indicates otherwise. All numerical values of parameters (e.g., of quantities or conditions) in this specification, unless otherwise indicated expressly or clearly in view of the context, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, a disclosure of a range is to be understood as specifically disclosing all values and further divided ranges within the range.

The terms “comprising”, “including”, and “having” are inclusive and therefore specify the presence of stated features, steps, operations, elements, or components, but do not preclude the presence or addition of one or more other features, steps, operations, elements, or components. Orders of steps, processes, and operations may be altered when possible, and additional or alternative steps may be employed. As used in this specification, the term “or” includes any one and all combinations of the associated listed items. The term “any of” is understood to include any possible combination of referenced items, including “any one of” the referenced items. The term “any of” is understood to include any possible combination of referenced claims of the appended claims, including “any one of” the referenced claims.

For consistency and convenience, directional adjectives may be employed throughout this detailed description corresponding to the illustrated embodiments. Those having ordinary skill in the art will recognize that terms such as “above”, “below”, “upward”, “downward”, “top”, “bottom”, etc., may be used descriptively relative to the figures, without representing limitations on the scope of the invention, as defined by the claims.

The following Clauses provide example configurations of a method and system for transferring multiple co-launched spacecraft 10 from a separation orbit 12 to a target orbit 120 as shown in the exemplary scenario of FIG. 3 and disclosed herein.

Clause 1: A method for controlling a phased transfer of multiple spacecraft from a separation orbit to a target orbit, the multiple spacecraft comprising a lead spacecraft and multiple follower spacecraft, the method comprising: while maintaining an in-phase relationship of the multiple spacecraft relative to each other within the separation orbit: computing, via a control system, respective desired trajectories for the lead spacecraft and the follower spacecrafts to reach the target orbit; and establishing a constant phase offset between the multiple spacecraft in a mean anomaly of the separation orbit; and during a series of transfer orbits of the multiple spacecraft from the separation orbit to the target orbit, applying the respective desired trajectories via the control system such that the constant phase offset is maintained and the follower spacecraft are simultaneously transferred to the target orbit in-phase with the lead spacecraft.

Clause 2: The method of clause 1, wherein applying the respective desired trajectories includes modifying an in-plane change in velocity (Δv) component of each of the multiple spacecraft in relation to an out-of-plane Δv component for each of the multiple spacecraft.

Clause 3: The method of clause 2, further comprising: implementing a compound steering law via the control system, the compound steering law having a plurality of weight factors, wherein modifying the in-plane Δv component in relation to the out-of-plane Δv component includes manipulating a predetermined one of the plurality of weight factors over a duration of the series of transfer orbits to thereby control a mean motion of each of the multiple spacecraft.

Clause 4: The method of clause 3, further comprising: calculating the mean motion of the multiple spacecraft as a function of respective semi-major axes of the multiple spacecraft; and calculating a phase rate needed to establish and maintain the constant phase offset between a sequential spacecraft pair of the multiple spacecraft in one or more the series of transfer orbits as a difference between the respective mean motion of the sequential spacecraft pair.

Clause 5: The method of any of clauses 1-4, wherein applying the respective desired trajectories includes applying a delta phase rate, including changing a relative semi-major axis between the sequential spacecraft pair at a defined rate according to a predetermined relationship.

Clause 6: The method of clause 5, wherein the predetermined relationship includes changing a semi-major axis of a designated spacecraft of the sequential spacecraft pair in relation to a semi-major axis of an additional spacecraft of the sequential spacecraft pair in a first direction until no more than half of a desired time to achieve the constant phase offset has elapsed, and thereafter changing the semi-major axis of the designated spacecraft in a second direction opposite the first direction until the desired time to achieve the constant phase offset has elapsed.

Clause 7. The method of clause 5, wherein the predetermined relationship includes changing the semi-major axis of the designated spacecraft in relation to the semi-major axis of the additional spacecraft in the first direction, holding the semi-major axis of the designated spacecraft at a fixed semi-major axis offset for a calibrated duration, and thereafter changing the semi-major axis of the designated spacecraft in the second direction opposite the first direction until the desired time to achieve the constant phase offset has elapsed.

Clause 8: The method of any of clauses 1-7, wherein maintaining the constant phase offset includes periodically repeating the method during the series of transfer orbits to account for thrust variations and/or mass variations between the multiple spacecraft.

Clause 9. The method of any of clauses 1-8, further comprising: deploying the multiple spacecraft from a single launch vehicle.

Clause 10. The method of clause 9, wherein deploying the multiple spacecraft from the single launch vehicle includes deploying multiple satellites from the single launch vehicle.

Clause 11: A control system operable for controlling a phased transfer of multiple spacecraft from a separation orbit to a target orbit, the multiple spacecraft comprising a lead spacecraft and multiple follower spacecraft, the control system comprising: a processor; and a tangible, non-transitory computer readable storage medium on which is recorded an instruction set, wherein execution of the instruction set by the processor causes the control system to: while maintaining an in-phase relationship of the multiple spacecraft relative to each other within the separation orbit: compute respective desired trajectories for the lead spacecraft and the follower spacecrafts to reach the target orbit; and establish a constant phase offset between the multiple spacecraft in a mean anomaly of the separation orbit; and during a series of transfer orbits of the multiple spacecraft from the separation orbit to the target orbit, apply the respective desired trajectories such that the constant phase offset is maintained and the follower spacecraft are simultaneously transferred to the target orbit in-phase with the lead spacecraft.

Clause 12. The control system of clause 11, wherein the execution of the instruction set by the processor causes the control system to apply the respective desired trajectories by modifying an in-plane change in velocity (Δv) component of each of the multiple spacecraft in relation to an out-of-plane Δv component for each of the multiple spacecraft.

Clause 13. The control system of clause 12, wherein the execution of the instruction set by the processor causes the control system to: implement a compound steering control law having a plurality of weight factors; and change the in-plane Δv component in relation to the out-of-plane Δv component by manipulating a predetermined one of the weight factors over a duration of the series of transfer orbits to thereby control a mean motion of each of the multiple spacecraft.

Clause 14. The control system of any of clauses 11-13, wherein the execution of the instruction set by the processor causes the control system to: calculate the mean motion of the multiple spacecraft as a function of respective semi-major axes of the multiple spacecraft; and calculate a delta phase rate needed to maintain the constant phase offset between a sequential spacecraft pair of the multiple spacecraft in one or more the series of transfer orbits as a difference between the respective mean motion of the sequential spacecraft pair.

Clause 15. The control system of clause 14, wherein the execution of the instruction set by the processor causes the control system to: apply the delta phase rate to the multiple spacecraft by changing a relative semi-major axis between the sequential spacecraft pair at a defined rate according to a predetermined relationship.

Clause 16. The control system of clause 14, wherein the predetermined relationship includes changing a semi-major axis of a designated spacecraft of the sequential spacecraft pair in relation to a semi-major axis of an additional spacecraft of the sequential spacecraft pair in a first direction until no more than half of a desired time to achieve the constant phase offset has elapsed, and thereafter changing the semi-major axis of the designated spacecraft in a second direction opposite the first direction until the desired time to achieve the constant phase offset has elapsed.

Clause 17. The control system of clause 16, wherein the predetermined relationship includes changing the semi-major axis of the designated spacecraft in relation to the semi-major axis of the additional spacecraft in the first predetermined direction, holding the semi-major axis of the designated spacecraft at a fixed semi-major axis offset for a calibrated duration, and thereafter changing the semi-major axis of the designated spacecraft in the second direction opposite the first direction until the desired time to achieve the constant phase offset has elapsed.

Clause 18. The control system of clause 11, wherein the execution of the instruction set by the processor causes the control system to: maintain the constant phase offset during the series of transfer orbits to account for thrust variations and/or mass variations between the multiple spacecraft.

Clause 19: A method for controlling a phased transfer of multiple spacecraft from a separation orbit to a target orbit, the multiple spacecraft comprising a lead spacecraft and multiple follower spacecraft, the method comprising: deploying the multiple spacecraft into a separation orbit from a single launch vehicle; while maintaining an in-phase relationship of the multiple spacecraft relative to each other within the separation orbit: implementing a compound steering control law via a control system, the compound steering law having a plurality of weight factors; computing, via the control system, respective desired trajectories for the lead spacecraft and the follower spacecrafts to reach the target orbit; and establishing a constant phase offset between the multiple spacecraft in a mean anomaly of the separation orbit; and during a series of transfer orbits of the multiple spacecraft from the separation orbit to the target orbit, applying the respective desired trajectories via the control system such that the constant phase offset is maintained and the follower spacecraft are simultaneously transferred to the target orbit in-phase with the lead spacecraft, including modifying an in-plane change in velocity (Δv) component of each of the multiple spacecraft in relation to an out-of-plane Δv component for each of the multiple spacecraft by manipulating a predetermined one of the weight factors over a duration of the series of transfer orbits to thereby control a mean motion of each of the multiple spacecraft.

Clause 20. The method of clause 19, further comprising: calculating the mean motion of the multiple spacecraft as a function of respective semi-major axes of the multiple spacecraft; and calculating a phase rate needed to maintain the constant phase offset between a sequential spacecraft pair of the multiple spacecraft in one or more the series of transfer orbits as a difference between the respective mean motion of the sequential spacecraft pair. While various embodiments have been described, the description is intended to be exemplary, rather than limiting and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

What is claimed is:

1. A method for controlling a phased transfer of multiple spacecraft from a separation orbit to a target orbit, the multiple spacecraft comprising a lead spacecraft and multiple follower spacecraft, the method comprising:
while maintaining an in-phase relationship of the multiple spacecraft relative to each other within the separation orbit:
computing, via a control system, respective desired trajectories for the lead spacecraft and the follower spacecrafts to reach the target orbit; and
establishing a constant phase offset between the multiple spacecraft in a mean anomaly of the separation orbit; and
during a series of transfer orbits of the multiple spacecraft from the separation orbit to the target orbit, applying the respective desired trajectories via the control system such that the constant phase offset is maintained and the follower spacecraft are simultaneously transferred to the target orbit in-phase with the lead spacecraft.

2. The method of claim 1, wherein applying the respective desired trajectories includes modifying an in-plane change in velocity (Δv) component of each of the multiple spacecraft in relation to an out-of-plane Δv component for each of the multiple spacecraft.

3. The method of claim 2, further comprising:
implementing a compound steering law via the control system, the compound steering law having a plurality of weight factors, wherein modifying the in-plane Δv component in relation to the out-of-plane Δv component includes manipulating a predetermined one of the plurality of weight factors over a duration of the series of transfer orbits to thereby control a mean motion of each of the multiple spacecraft.

4. The method of claim 3, further comprising:
calculating the mean motion of the multiple spacecraft as a function of respective semi-major axes of the multiple spacecraft; and
calculating a phase rate needed to establish and maintain the constant phase offset between a sequential spacecraft pair of the multiple spacecraft in one or more the series of transfer orbits as a difference between the respective mean motion of the sequential spacecraft pair.

5. The method of claim 4, wherein applying the respective desired trajectories includes applying a delta phase rate, including changing a relative semi-major axis between the sequential spacecraft pair at a defined rate according to a predetermined relationship.

6. The method of claim 5, wherein the predetermined relationship includes changing a semi-major axis of a designated spacecraft of the sequential spacecraft pair in relation to a semi-major axis of an additional spacecraft of the sequential spacecraft pair in a first direction until no more than half of a desired time to achieve the constant phase offset has elapsed, and thereafter changing the semi-major axis of the designated spacecraft in a second direction opposite the first direction until the desired time to achieve the constant phase offset has elapsed.

7. The method of claim 6, wherein the predetermined relationship includes changing the semi-major axis of the designated spacecraft in relation to the semi-major axis of the additional spacecraft in the first direction, holding the semi-major axis of the designated spacecraft at a fixed semi-major axis offset for a calibrated duration, and thereafter changing the semi-major axis of the designated spacecraft in the second direction opposite the first direction until the desired time to achieve the constant phase offset has elapsed.

8. The method of claim 1, wherein maintaining the constant phase offset includes periodically repeating the method during the series of transfer orbits to account for thrust variations and/or mass variations between the multiple spacecraft.

9. The method of claim 1, further comprising:
deploying the multiple spacecraft from a single launch vehicle.

10. The method of claim 9, wherein deploying the multiple spacecraft from the single launch vehicle includes deploying multiple satellites from the single launch vehicle.

11. A control system operable for controlling a phased transfer of multiple spacecraft from a separation orbit to a target orbit, the multiple spacecraft comprising a lead spacecraft and multiple follower spacecraft, the control system comprising:
a processor; and
a tangible, non-transitory computer readable storage medium on which is recorded an instruction set, wherein execution of the instruction set by the processor causes the control system to:
while maintaining an in-phase relationship of the multiple spacecraft relative to each other within the separation orbit:
compute respective desired trajectories for the lead spacecraft and the follower spacecraft to reach the target orbit; and
establish a constant phase offset between the multiple spacecraft in mean anomaly of the separation orbit; and
during a series of transfer orbits of the multiple spacecraft from the separation orbit to the target orbit, apply the respective desired trajectories such that the constant phase offset is maintained and the follower spacecraft are simultaneously transferred to the target orbit in-phase with the lead spacecraft.

12. The control system of claim 11, wherein the execution of the instruction set by the processor causes the control system to apply the respective desired trajectories by modifying an in-plane change in velocity (Δv) component of each of the multiple spacecraft in relation to an out-of-plane Δv component for each of the multiple spacecraft.

13. The control system of claim 12, wherein the execution of the instruction set by the processor causes the control system to:
implement a compound steering control law having a plurality of weight factors; and
change the in-plane Δv component in relation to the out-of-plane Δv component by manipulating a predetermined one of the weight factors over a duration of the series of transfer orbits to thereby control a mean motion of each of the multiple spacecraft.

14. The control system of claim 11, wherein the execution of the instruction set by the processor causes the control system to:
calculate the mean motion of the multiple spacecraft as a function of respective semi-major axes of the multiple spacecraft; and
calculate a delta phase rate needed to maintain the constant phase offset between a sequential spacecraft pair of the multiple spacecraft in one or more the series of transfer orbits as a difference between the respective mean motion of the sequential spacecraft pair.

15. The control system of claim 14, wherein the execution of the instruction set by the processor causes the control system to:
apply the delta phase rate to the multiple spacecraft by changing a relative semi-major axis between the sequential spacecraft pair at a defined rate according to a predetermined relationship.

16. The control system of claim 15, wherein the predetermined relationship includes changing a semi-major axis of a designated spacecraft of the sequential spacecraft pair in relation to a semi-major axis of an additional spacecraft of the sequential spacecraft pair in a first direction until no more than half of a desired time to achieve the constant phase offset has elapsed, and thereafter changing the semi-major axis of the designated spacecraft in a second direction opposite the first direction until the desired time to achieve the constant phase offset has elapsed.

17. The control system of claim 16, wherein the predetermined relationship includes changing the semi-major axis of the designated spacecraft in relation to the semi-major axis of the additional spacecraft in the first predetermined direction, holding the semi-major axis of the designated spacecraft at a fixed semi-major axis offset for a calibrated duration, and thereafter changing the semi-major axis of the designated spacecraft in the second direction opposite the first direction until the desired time to achieve the constant phase offset has elapsed.

18. The control system of claim 11, wherein the execution of the instruction set by the processor causes the control system to:
maintain the constant phase offset during the series of transfer orbits to account for thrust variations and/or mass variations between the multiple spacecraft.

19. A method for controlling a phased transfer of multiple spacecraft from a separation orbit to a target orbit, the multiple spacecraft comprising a lead spacecraft and multiple follower spacecraft, the method comprising:
deploying the multiple spacecraft into the separation orbit from a single launch vehicle;
while maintaining an in-phase relationship of the multiple spacecraft relative to each other within the separation orbit:
implementing a compound steering control law via a control system, the compound steering law having a plurality of weight factors;
computing, via the control system, respective desired trajectories for the lead spacecraft and the follower spacecraft to reach the target orbit; and
establishing a constant phase offset between the multiple spacecraft in mean anomaly of the separation orbit; and
during a series of transfer orbits of the multiple spacecraft from the separation orbit to the target orbit, applying the respective desired trajectories via the control system such that the constant phase offset is maintained and the follower spacecraft are simultaneously transferred to the target orbit in-phase with the lead spacecraft, including
modifying an in-plane change in velocity (Δv) component of each of the multiple spacecraft in relation to an out-of-plane Δv component for each of the multiple spacecraft by manipulating a predetermined one of the weight factors over a duration of the series of transfer orbits to thereby control a mean motion of each of the multiple spacecraft.

20. The method of claim 19, further comprising:
calculating the mean motion of the multiple spacecraft as a function of respective semi-major axes of the multiple spacecraft; and
calculating a phase rate needed to maintain the constant phase offset between a sequential spacecraft pair of the multiple spacecraft in one or more the series of transfer orbits as a difference between the mean motion of respective spacecraft of the sequential spacecraft pair.
